(19) United States
(12) Patent Application Publication
(10) Pub. No.: US 2024/0086972 A1
(43) Pub. Date: Mar. 14, 2024

(54) INFORMATION DISTRIBUTION METHOD, APPARATUS AND COMPUTER READABLE STORAGE MEDIUM

(71) Applicant: Lemon Inc., Grand Cayman (KY)

(72) Inventors: Xudong YANG, Beijing (CN); Haocheng Zhang, Los Angeles, CA (US); Hongyu Xiong, Los Angeles, CA (US); Jin Jiang, Beijing (CN); Bin Liu, Los Angeles, CA (US)

(21) Appl. No.: 18/462,916

(22) Filed: Sep. 7, 2023

(30) Foreign Application Priority Data
Sep. 8, 2022 (CN) 20221109644306

(51) Int. Cl. G06Q 30/0251; G06N 3/02

(52) U.S. Cl. CPC G06Q 30/0271; G06N 3/02; G06Q 30/0255

(57) ABSTRACT

The present disclosure relates to an information distribution method, apparatus, and computer readable storage medium, which relates to the field of information processing. The information distribution method includes: determining a recommended value of a target indicator corresponding to a user based on a historical indicator of information historically distributed by the user and a historical indicator of a category to which the user belongs, wherein an indicator is determined based on resources gained and consumed through distributed information; recommending the recommended value of the target indicator to the user; determining target recipients of target information to be distributed by the user based on a target indicator input by the user, wherein the target indicator input by the user is determined based on the recommended value of the target indicator by the user; and sending the target information to the target recipients.

### CROSS-REFERENCE TO RELATED APPLICATIONS

This application claims the priority of Chinese Application for Invention No. 202211096443.6, filed to the Patent Office of the People's Republic of China on Sep. 8, 2022, entitled “INFORMATION DISTRIBUTION METHOD, APPARATUS AND COMPUTER READABLE STORAGE MEDIUM”, the entire content of which is incorporated herein by reference.

### TECHNICAL FIELD

The present disclosure relates to the field of information processing, and more particularly to an information distribution method, apparatus and computer readable storage medium.

### BACKGROUND

Information distribution is a process of sending information to terminal devices. In Internet technology, information distribution is usually targeted. For example, a target recipient should be identified in order to send information to the target recipient for better feedback.

### SUMMARY

According to a first aspect of some embodiments of the present disclosure, there is provided an information distribution method, comprising: determining a recommended value of a target indicator corresponding to a user based on a historical indicator of information historically distributed by the user and a historical indicator of a category to which the user belongs, wherein an indicator is determined based on resources gained and consumed through distributed information; recommending the recommended value of the target indicator to the user; determining target recipients of target information to be distributed by the user based on a target indicator input by the user, wherein the target indicator input by the user is determined based on the recommended value of the target indicator by the user; and sending the target information to the target recipients.

In some embodiments, the determining the recommended value of the target indicator corresponding to the user based on the historical indicator of the information historically distributed by the user and the historical indicator of the category to which the user belongs comprises: determining a product of the historical indicator of the information historically distributed by the user and a user coefficient as a first value; determining a product of the historical indicator of the category to which the user belongs and a category coefficient as a second value; and determining a maximum of the first value and the second value as the recommended value of the target indicator.

In some embodiments, the user coefficient is not greater than 3, and the category coefficient is between 0.7 and 0.9.

In some embodiments, the user coefficient is 3, and the category coefficient is 0.8.

In some embodiments, the information distribution method further comprises: determining a ratio of an indicator set by a user corresponding to each of multiple pieces of distributed information to an average indicator of a category to which the user belongs; dividing the multiple pieces of the distributed information according to preset intervals to which ratios of the multiple pieces of the distributed information belong; determining a completion rate of information corresponding to each of the intervals, wherein the completion rate is a ratio of a number of pieces of information each having an actual indicator not lower than a preset target indicator after information distribution to a number of pieces of information corresponding to the interval; and determining the user coefficient based on a degree of decrease in the completion rate corresponding to each of the intervals with respect to a previous interval.

In some embodiments, the multiple pieces of the distributed information are published information corresponding to at least one of a distribution platform or a distribution region of the target information.

In some embodiments, the recommending the recommended value of the target indicator to the user comprises: recommending the recommended value of the target indicator to the user in a case where a target indicator previously input by the user is not within a preset range.

In some embodiments, the determining the target recipients of the target information to be distributed by the user based on the target indicator input by the user comprises: for each recipient in a candidate recipient dataset, generating joint features of the recipient based on features of the recipient and features of the target information to be distributed by the user; processing the joint features of the recipient using a pre-trained model to generate a predicted value; and determining the recipient as a target recipient of the target information in a case where the predicted value meets a preset condition, wherein the preset condition is determined based on the target indicator input by the user.

In some embodiments, the information distribution method further comprises: in a process of sending the target information to the target recipients, displaying at least one of the recommended value of the target indicator, drop information, gained resources, consumed resources or indicator(s) of the target information in real time by information visualization, wherein the drop information corresponding to each time is a ratio of resources gained at the time to resources gained at a previous time.

In some embodiments, the information distribution method further comprises: in a process of sending the target information to the target recipients, monitoring drop information of the target information, wherein the drop information corresponding to each time is a ratio of resources gained at the time to resources gained at a previous time; and recommending the recommended value of the target indicator to the user again in a case where the drop information is higher than a preset value and the target indicator input by the user is not the recommended value of the target indicator.

In some embodiments, the information distribution method further comprises: obtaining distribution completion information of the target information after a distribution of the target information is completed, wherein the distribution completion information is determined based on a target indicator corresponding to the distribution and the target indicator input by the user; and recommending the recommended value of the target indicator to the user again in a case where the target indicator input by the user is not the recommended value of the target indicator and the distribution completion information does not meet a preset condition.

According to a second aspect of some embodiments of the present disclosure, there is provided an information distribution apparatus, comprising: a memory; and a processor coupled to the memory, the processor configured to, based on instructions stored in the memory, carry out an information distribution method comprising:
determining a recommended value of a target indicator corresponding to a user based on a historical indicator of information historically distributed by the user and a historical indicator of a category to which the user belongs, wherein an indicator is determined based on resources gained and consumed through distributed information;
recommending the recommended value of the target indicator to the user;
determining target recipients of target information to be distributed by the user based on a target indicator input by the user, wherein the target indicator input by the user is determined based on the recommended value of the target indicator by the user; and
sending the target information to the target recipients.

In some embodiments, the processor is configured to: determine a product of the historical indicator of the information historically distributed by the user and a user coefficient as a first value; determine a product of the historical indicator of the category to which the user belongs and a category coefficient as a second value; and determine a maximum of the first value and the second value as the recommended value of the target indicator.

In some embodiments, the user coefficient is not greater than 3, and the category coefficient is between 0.7 and 0.9.

In some embodiments, the user coefficient is 3, and the category coefficient is 0.8.

In some embodiments, the processor is configured to: determine a ratio of an indicator set by a user corresponding to each of multiple pieces of distributed information to an average indicator of a category to which the user belongs; divide the multiple pieces of the distributed information according to preset intervals to which ratios of the multiple pieces of the distributed information belong; determine a completion rate of information corresponding to each of the intervals, wherein the completion rate is a ratio of a number of pieces of information each having an actual indicator not lower than a preset target indicator after information distribution to a number of pieces of information corresponding to the interval; and determine the user coefficient based on a degree of decrease in the completion rate corresponding to each of the intervals with respect to a previous interval.

In some embodiments, the multiple pieces of the distributed information are published information corresponding to at least one of a distribution platform or a distribution region of the target information.

In some embodiments, the processor is configured to: recommend the recommended value of the target indicator to the user in a case where a target indicator previously input by the user is not within a preset range.

In some embodiments, the processor is configured to: for each recipient in a candidate recipient dataset, generating joint features of the recipient based on features of the recipient and features of the target information to be distributed by the user; processing the joint features of the recipient using a pre-trained model to generate a predicted value; and determining the recipient as a target recipient of the target information in a case where the predicted value meets a preset condition, wherein the preset condition is determined based on the target indicator input by the user.

In some embodiments, the processor is configured to: in a process of sending the target information to the target recipients, display at least one of the recommended value of the target indicator, drop information, gained resources, consumed resources or indicator(s) of the target information in real time by information visualization, wherein the drop information corresponding to each time is a ratio of resources gained at the time to resources gained at a previous time.

In some embodiments, the processor is configured to: in a process of sending the target information to the target recipients, monitor drop information of the target information, wherein the drop information corresponding to each time is a ratio of resources gained at the time to resources gained at a previous time; and recommend the recommended value of the target indicator to the user again in a case where the drop information is higher than a preset value and the target indicator input by the user is not the recommended value of the target indicator.

In some embodiments, the processor is configured to: obtain distribution completion information of the target information after a distribution of the target information is completed, wherein the distribution completion information is determined based on a target indicator corresponding to the distribution and the target indicator input by the user; and recommend the recommended value of the target indicator to the user again in a case where the target indicator input by the user is not the recommended value of the target indicator and the distribution completion information does not meet a preset condition. According to a third aspect of some embodiments of the present disclosure, there is provided a non-transitory computer-readable storage medium on which a computer program is stored, wherein the program when executed by a processor carries out an information distribution method comprising: determining a recommended value of a target indicator corresponding to a user based on a historical indicator of information historically distributed by the user and a historical indicator of a category to which the user belongs, wherein an indicator is determined based on resources gained and consumed through distributed information; recommending the recommended value of the target indicator to the user; determining target recipients of target information to be distributed by the user based on a target indicator input by the user, wherein the target indicator input by the user is determined based on the recommended value of the target indicator by the user; and sending the target information to the target recipients.

In some embodiments, the determining the recommended value of the target indicator corresponding to the user based on the historical indicator of the information historically distributed by the user and the historical indicator of the category to which the user belongs comprises: determining a product of the historical indicator of the information historically distributed by the user and a user coefficient as a first value; determining a product of the historical indicator of the category to which the user belongs and a category coefficient as a second value; and determining a maximum of the first value and the second value as the recommended value of the target indicator.

In some embodiments, the user coefficient is not greater than 3, and the category coefficient is between 0.7 and 0.9.

In some embodiments, the user coefficient is 3, and the category coefficient is 0.8.

In some embodiments, the information distribution method further comprises: determining a ratio of an indicator set by a user corresponding to each of multiple pieces of distributed information to an average indicator of a category to which the user belongs; dividing the multiple pieces of the distributed information according to preset intervals to which ratios of the multiple pieces of the distributed information belong; determining a completion rate of information corresponding to each of the intervals, wherein the completion rate is a ratio of a number of pieces of information each having an actual indicator not lower than a preset target indicator after information distribution to a number of pieces of information corresponding to the interval; and determining the user coefficient based on a degree of decrease in the completion rate corresponding to each of the intervals with respect to a previous interval.

In some embodiments, the multiple pieces of the distributed information are published information corresponding to at least one of a distribution platform or a distribution region of the target information.

In some embodiments, the recommending the recommended value of the target indicator to the user comprises: recommending the recommended value of the target indicator to the user in a case where a target indicator previously input by the user is not within a preset range.

In some embodiments, the determining the target recipients of the target information to be distributed by the user based on the target indicator input by the user comprises: for each recipient in a candidate recipient dataset, generating joint features of the recipient based on features of the recipient and features of the target information to be distributed by the user; processing the joint features of the recipient using a pre-trained model to generate a predicted value; and determining the recipient as a target recipient of the target information in a case where the predicted value meets a preset condition, wherein the preset condition is determined based on the target indicator input by the user.

In some embodiments, the information distribution method further comprises: in a process of sending the target information to the target recipients, displaying at least one of the recommended value of the target indicator, drop information, gained resources, consumed resources or indicator(s) of the target information in real time by information visualization, wherein the drop information corresponding to each time is a ratio of resources gained at the time to resources gained at a previous time.

In some embodiments, the information distribution method further comprises: in a process of sending the target information to the target recipients, monitoring drop information of the target information, wherein the drop information corresponding to each time is a ratio of resources gained at the time to resources gained at a previous time; and recommending the recommended value of the target indicator to the user again in a case where the drop information is higher than a preset value and the target indicator input by the user is not the recommended value of the target indicator.

In some embodiments, the information distribution method further comprises: obtaining distribution completion information of the target information after a distribution of the target information is completed, wherein the distribution completion information is determined based on a target indicator corresponding to the distribution and the target indicator input by the user; and recommending the recommended value of the target indicator to the user again in a case where the target indicator input by the user is not the recommended value of the target indicator and the distribution completion information does not meet a preset condition.

Other features and advantages of the present invention will become apparent from the following detailed description of exemplary embodiments of the present disclosure with reference to the accompanying drawings.

### BRIEF DESCRIPTION OF THE DRAWINGS

In order to more clearly explain the embodiments of the present invention or the technical solutions in the prior art, a brief introduction will be given below for the drawings required to be used in the description of the embodiments or the prior art. It is obvious that, the drawings illustrated as follows are merely some embodiments of the present disclosure. For a person skilled in the art, he or she may also acquire other drawings according to such drawings on the premise that no inventive effort is involved.

FIG. 1 shows a flowchart of an information distribution method according to some embodiments of the present disclosure;

FIG. 2 shows a flowchart of a user coefficient determination method according to some embodiments of the present disclosure;

FIG. 3 shows a schematic structural diagram of an information distribution apparatus according to some embodiments of the present disclosure;

FIG. 4 shows a schematic structural diagram of an information distribution apparatus according to other embodiments of the present disclosure;

FIG. 5 shows a schematic structural diagram of an information distribution apparatus according to still other embodiments of the present disclosure.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The following description of at least one exemplary embodiment is in fact merely illustrative and is in no way intended as a limitation to the invention, its application or use. All other embodiments obtained by persons of ordinary skill in the art based on the embodiments of the present disclosure without creative efforts shall fall within the protection scope of the present disclosure.

Unless otherwise specified, the relative arrangement, numerical expressions and numerical values of the components and steps set forth in these examples do not limit the scope of the invention.

At the same time, it should be understood that, for ease of description, the dimensions of the various parts shown in the drawings are not drawn to actual proportions.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an item is defined in a drawing, there is no need for further discussion in the accompanying drawings.

It can be understood that prior to using the technical solutions of the various embodiments of this disclosure, users are informed in a suitable manner about the type of personal information involved, the scope of use and application scenarios of the personal information, etc., and authorization is obtained from the users.

For example, in response to receiving a user's active request, a prompt message is sent to the user to clearly inform the user that the requested operation requires the collection and use of the user's personal information. Thus, the user can independently choose whether to provide personal information to software or hardware, such as an electronic device, application, server, or storage media, that performs the operation of the disclosed technical solution based on the prompted information.

As an optional but not limited implementation method, in response to receiving an active user request, a prompt message may be sent to the user via a pop-up window in which a text prompt message may be presented. In addition, the pop-up window may also comprise a selection control for the user to choose whether to “agree” or “disagree” to provide personal information to the electronic device.

It can be understood that the above notification and user authorization process is only illustrative and does not constitute a limitation on the implementation method of this disclosure. Other methods that comply with relevant laws and regulations may also be applied to the implementation method of this disclosure.

After analysis, it is found that in order to better assist a user with a request for information distribution, it is necessary to understand the user's distribution expectation in advance and determine target recipients based on that expectation. However, some users' distribution requirements are set unreasonably, which can lead to poor distribution results, wasting user resources consumed during the distribution process, as well as network resources, computing resources, storage resources, and resources of target recipients who do not want to receive the distribution information.

Therefore, the inventors proposed an information distribution method, apparatus, and computer-readable storage medium to address the problem of resource waste caused by inaccurate information distribution.

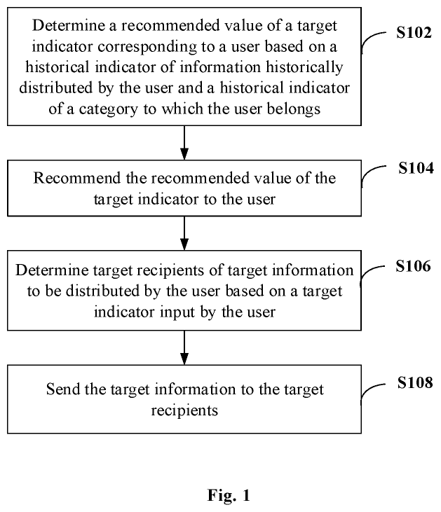

FIG. 1 shows a flowchart of an information distribution method according to some embodiments of the present disclosure. As shown in FIG. 1, the information distribution method of this embodiment comprises steps S102 to S108.

In step S102, a recommended value of a target indicator corresponding to a user is determined based on a historical indicator of information historically distributed by the user and a historical indicator of a category to which the user belongs, wherein an indicator is determined based on resources gained and consumed through distributed information.

In this disclosure, the user is a user distributing information, and the recipient is the recipient of the distributed information. The distributed information may be text, images, videos, sounds, or any combination of the above, for example. After a target recipient receives the information, feedback may be generated if he/she is interested in the information, comprising for example providing positive remarks (such as likes) and interaction with an item associated with the information. This interaction comprises clicking, browsing, bookmarking, sharing, purchasing and so on. For example, if the distributed information is a product introduction, and if a user who receives the information is interested, he/she may click on an Entry control on a purchase page of the product, thereby generating interactive behaviors such as browsing, bookmarking, sharing, and purchasing. Here, the method for collecting and using personal information has been described above. Personal information may be collected and used with the authorization of both the user who distributes information and the target recipient.

The category of the user can be determined based on his/her industry, such as clothing, education, automotive, catering, healthcare and so on. In some embodiments, the category of the user is determined based on the category of the target information to be distributed. For example, if all the historical information distributed by a user is related to catering, the user's category is determined as catering. In addition, the user's category can also be determined based on his/her settings.

For example, the resources comprise time resources, capital resources, interactive resources such as click-through rate and page views, and may also be network resources, computing resources or storage resources.

The indicator is used to measure the distribution effectiveness for a user and a user category in historical distribution processes. For example, the historical indicator is an average of the indicator over a historical period. In some embodiments, the indicator is a ratio of resources gained to resources consumed by information distribution, which is a measure of the user's return due to information distribution.

In some embodiments, a product of the historical indicator of information historically distributed by the user and a user coefficient is determined as a first value; a product of the historical indicator of the category to which the user belongs and a category coefficient is determined as a second value; and a maximum of the first value and the second value is determined as the recommended value of the target indicator. In some embodiments, the user coefficient is not greater than 3, and the category coefficient is between 0.7 and 0.9.

After analysis, the inventors have found that different categories have different characteristics. For example, users who mainly distribute virtual product information consume fewer resources when distributing information because virtual product materials consume fewer transport and storage resources, thereby resulting in a relatively low target indicator; users who mainly distribute information about clothing products often have higher expectations for the target indicator. Therefore, in the above example, the historical indicator of the category is taken into account when determining the recommended value. Moreover, if there is less or even no historical data of the user, the historical indicator of the industry can also provide an alternative recommendation solution. Thus, the user can be provided with a reasonable and effective recommendation value.

In step S104, the recommended value of the target indicator is recommended to the user.

In some embodiments, it is also possible to receive a target indicator previously input by the user and determine whether the target indicator is within a preset range; the recommended value of the target indicator is then recommended to the user in a case where the target indicator input by the user is not within the preset range. Thus, the user can refer to the recommended value and determines a target indicator to be used.

The user can adopt the recommended value, for example, by selecting a control on a page and directly inputting the recommended value into the input control of the target indicator. In addition, the user can also enter his/her own value, wherein a value equal to the recommended value can be entered, or the user can make an adjustment based on the recommended value to enter a desired value, or if the user does not agree with the recommended value, another desired value can be entered. In summary, the user can make a decision such as agree, basically agree, or disagree based on the recommended value, and fill in a value based on this decision.

In some embodiments, in a case where the user has previously entered a target indicator but the target indicator is not within a preset range, a prompt for a recommended value is displayed on the input page. In this case, based on the recommended value, the user can change the target indicator entered or leave the target indicator originally entered unchanged.

For example, the user can determine the target indicator by manipulating a Submit control on the page. Then, the user's terminal, for example, sends the submitted recommendation value to a server for further calculation.

In step S106, target recipients of target information to be distributed by the user are determined based on a target indicator input by the user, wherein the target indicator input by the user is determined based on the recommended value of the target indicator by the user.

In some embodiments, a pre-trained model is used to determine the target recipients. The model is, for example, a neural network model.

In some embodiments, for each recipient in a candidate recipient dataset, joint features of the recipient are generated based on features of the recipient and features of the target information to be distributed by the user; the joint features of the recipient are processed using a pre-trained model to generate a predicted value; and the recipient is determined as a target recipient of the target information in a case where the predicted value meets a preset condition, wherein the preset condition is determined based on the target indicator input by the user.

The predicted value represents a probability of the recipient providing feedback on the target information. The feedback may comprise clicking, browsing, bookmarking, sharing or purchasing, and can be measured by a click-through rate, a conversion rate, a resource consumption value, etc.

Through this determination method, recipients that are most likely to generate feedback can be identified as the target recipients, so that the overall effect of information distribution can meet the target indicator input by the user and the user's expectations.

In step S108, the target information is sent to the target recipients.

For example, the target information is sent to terminals of the target recipients.

In some embodiments, the target information is continuously distributed for a preset duration. The distribution method may comprise continuous distributing to a target user within a predetermined period of time, for example displaying the target information at a fixed location in a particular application. Alternatively, it may involve sending the target information a predetermined number of times to each target recipient within a predetermined period of time, either through push notifications or display at a fixed location in an application. Other presentation methods can also be used by those skilled in the art according to their needs, which will not be described in detail.

In the above embodiment, a recommended value of the target indicator is determined based on a historical indicator of information historically distributed by the user and a historical indicator corresponding to the category to which the user belongs, in order to generate a prompt to the user when inputting the target indicator, so that the user can set a reasonable target indicator based on the recommended value. Therefore, the information distribution determined based on the input target indicator is more reasonable, avoiding repeated distribution processes or resource waste caused by poor information distribution effect, and thus saving the user's resources, as well as the resources of the network, device and target recipients.

In some embodiments, a user coefficient and a category coefficient are used when determining the recommended value of the target indicator, that is, a product of the historical indicator of the information historically distributed by the user and a user coefficient is determined as a first value; a product of the historical indicator of the category to which the user belongs and a category coefficient is determined as a second value; and a maximum of the first value and the second value is determined as the recommended value of the target indicator. An example of how to determine the user coefficient will be described below.

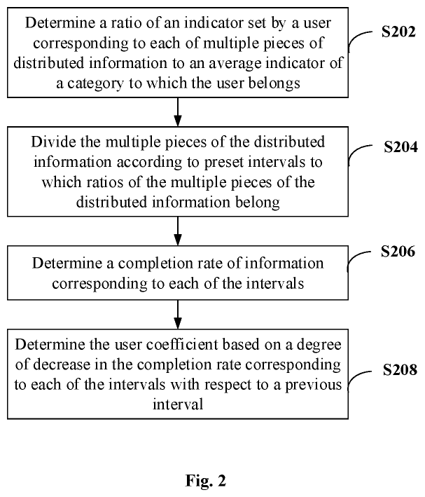

FIG. 2 shows a flowchart of a user coefficient determination method according to some embodiments of the present disclosure. As shown in FIG. 2, the user coefficient determination method of this embodiment comprises steps S202 to S208.

In step S202, a ratio of an indicator set by a user corresponding to each of multiple pieces of distributed information to an average indicator of a category to which the user belongs is determined.

In step S204, the multiple pieces of the distributed information are divided according to preset intervals to which ratios of the multiple pieces of the distributed information belong. For example, information with a ratio between 0 and 1 are divided into interval 1, information with a ratio between 1 and 2 are divided into interval 2, and so on.

In step S206, a completion rate of information corresponding to each of the intervals is determined, wherein the completion rate is a ratio of a number of pieces of information each having an actual indicator not lower than a preset target indicator after information distribution to a number of pieces of information corresponding to the interval.

In step S208, the user coefficient is determined based on a degree of decrease in the completion rate corresponding to each of the intervals with respect to a previous interval.

For example, for two adjacent intervals, in a case where the completion rate of the successive interval is significantly lower than that of the previous interval, e.g. a preset level is exceeded, a boundary point between the two intervals is used as the user coefficient. Table 1 provides an example of the range of ratios and corresponding completion rates for several intervals.

TABLE 1

| Ratio | 0~1 | 1~2 | 2~3 | >3 |
|---|---|---|---|---|
| Completion | 70% | 50% | 49% | 10% |
| Rate | | | | |

From Table 1 it can be seen that when the ratio is greater than 3, the completion rate drops sharply, so the user coefficient can be set to 3.

The inventors have found through statistical analysis of some historical data that a better information distribution effect can be achieved when the user coefficient is 3 and the category coefficient is 0.8. As the data expands, those skilled in the art can also adjust the coefficients as needed.

In some embodiments, in the determination of the user coefficient, the multiple pieces of the distributed information are published information corresponding to at least one of a distribution platform or a distribution region of the target information. Thus, for users with different targeting regions and platforms, personalized coefficients can be determined to more flexibly determine the recommended value, thereby leading to better distribution effect and saving more resources.

In some embodiments, the distribution effect can also be monitored during the distribution process.

In some embodiments, in a process of sending the target information to the target recipients, at least one of the recommended value of the target indicator, drop information, gained resources, consumed resources or indicator(s) of the target information are displayed in real time by information visualization, wherein the drop information corresponding to each time is a ratio of resources gained at the time to resources gained at a previous time.

For example, drop information can be displayed in a form of a histogram, line chart, etc. Thus, users can have a clear understanding of the current distribution effect. Further, the recommended value of the target indicator can also be displayed to the user. Therefore, if a user who has not previously adopted the recommended value notices a significant drop, he/she can consider optimizing the distribution strategy in a new distribution by using the recommended value.

In some embodiments, it is also possible to initiate a prompt to the user when the drop is significant. In a process of sending the target information to the target recipients, drop information of the target information is monitored, wherein the drop information corresponding to each time is a ratio of resources gained at the time to resources gained at a previous time; and the recommended value of the target indicator is recommended to the user again in a case where the drop information is higher than a preset value and the target indicator input by the user is not the recommended value of the target indicator.

This enables a more targeted recommendation to be made, making it easier for the user to accept the recommended value and, if necessary, adjust the distribution strategy in a timely manner, thereby improving the accuracy of information distribution and saving resources.

In some embodiments, it is also possible to initiate a prompt to the user based on the completion situation after the distribution process. Distribution completion information of the target information is obtained after a distribution of the target information is completed, wherein the distribution completion information is determined based on a target indicator corresponding to the distribution and the target indicator input by the user; and the recommended value of the target indicator is recommended to the user again in a case where the target indicator input by the user is not the recommended value of the target indicator and the distribution completion information does not meet a preset condition.

This allows the user to take the recommended value into account the next time information is distributed or the distributed information is re-distributed, which can improve the accuracy of information distribution and save resources.

An embodiment of an information distribution apparatus of the present disclosure will be described below with reference to FIG. 3.

FIG. 3 shows a schematic structural diagram of an information distribution apparatus according to some embodiments of the present disclosure. As shown in FIG. 3, the information distribution apparatus 30 of this embodiment comprises: a recommended value determination module 310 for determining a recommended value of a target indicator corresponding to a user based on a historical indicator of information historically distributed by the user and a historical indicator of a category to which the user belongs, wherein an indicator is determined based on resources gained and consumed through distributed information; a recommending module 320 for recommending the recommended value of the target indicator to the user; a target recipient determination module 330 for determining target recipients of target information to be distributed by the user based on a target indicator input by the user, wherein the target indicator input by the user is determined based on the recommended value of the target indicator by the user; and a distribution module 340 for sending the target information to the target recipients.

In some embodiments, the recommended value determination module 310 is further configured for determining a product of the historical indicator of the information historically distributed by the user and a user coefficient as a first value; determining a product of the historical indicator of the category to which the user belongs and a category coefficient as a second value; and determining a maximum of the first value and the second value as the recommended value of the target indicator.

In some embodiments, the user coefficient is not greater than 3, and the category coefficient is between 0.7 and 0.9.

In some embodiments, the user coefficient is 3, and the category coefficient is 0.8.

In some embodiments, the information distribution apparatus 30 further comprises a user coefficient determination module 350 for determining a ratio of an indicator set by a user corresponding to each of multiple pieces of distributed information to an average indicator of a category to which the user belongs; dividing the multiple pieces of the distributed information according to preset intervals to which ratios of the multiple pieces of the distributed information belong; determining a completion rate of information corresponding to each of the intervals, wherein the completion rate is a ratio of a number of pieces of information each having an actual indicator not lower than a preset target indicator after information distribution to a number of pieces of information corresponding to the interval; and determining the user coefficient based on a degree of decrease in the completion rate corresponding to each of the intervals with respect to a previous interval.

In some embodiments, the multiple pieces of the distributed information are published information corresponding to at least one of a distribution platform or a distribution region of the target information.

In some embodiments, the recommending module 320 is further configured for recommending the recommended value of the target indicator to the user in a case where a target indicator previously input by the user is not within a preset range.

In some embodiments, the target recipient determination module 330 is further configured for, for each recipient in a candidate recipient dataset, generating joint features of the recipient based on features of the recipient and features of the target information to be distributed by the user; processing the joint features of the recipient using a pre-trained model to generate a predicted value; and determining the recipient as a target recipient of the target information in a case where the predicted value meets a preset condition, wherein the preset condition is determined based on the target indicator input by the user.

In some embodiments, the information distribution apparatus 30 further comprises: a display module 360 for, in a process of sending the target information to the target recipients, displaying at least one of the recommended value of the target indicator, drop information, gained resources, consumed resources or indicator(s) of the target information in real time by information visualization, wherein the drop information corresponding to each time is a ratio of resources gained at the time to resources gained at a previous time.

In some embodiments, the information distribution apparatus 30 further comprises: a monitoring module 370 for, in a process of sending the target information to the target recipients, monitoring drop information of the target information, wherein the drop information corresponding to each time is a ratio of resources gained at the time to resources gained at a previous time; and the recommending module 320 is further configured for recommending the recommended value of the target indicator to the user again in a case where the drop information is higher than a preset value and the target indicator input by the user is not the recommended value of the target indicator.

In some embodiments, the recommending module 320 is further configured for obtaining distribution completion information of the target information after a distribution of the target information is completed, wherein the distribution completion information is determined based on a target indicator corresponding to the distribution and the target indicator input by the user; and recommending the recommended value of the target indicator to the user again in a case where the target indicator input by the user is not the recommended value of the target indicator and the distribution completion information does not meet a preset condition.

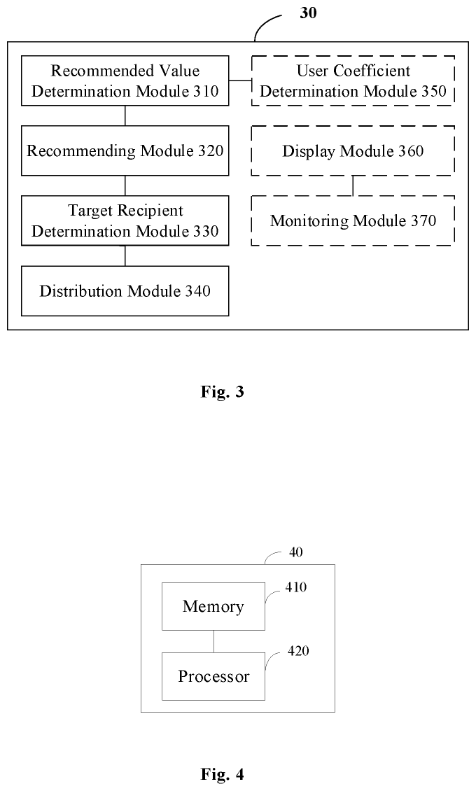

FIG. 4 shows a schematic structural diagram of an information distribution apparatus according to other embodiments of the present disclosure. As shown in FIG. 4, the information distribution apparatus 40 of this embodiment comprises: a memory 410 and a processor 420 coupled to the memory 410, the processor 420 configured to, based on instructions stored in the memory 410, carry out the information distribution method according to any one of the foregoing embodiments.

The memory 410 may include, for example, system memory, a fixed non-volatile storage medium, or the like. The system memory stores, for example, an operating system, application programs, a boot loader, and other programs.

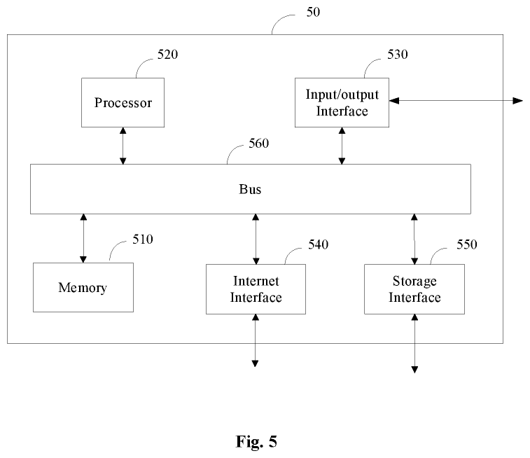

FIG. 5 shows a schematic structural diagram of an information distribution apparatus according to still other embodiments of the present disclosure. As shown in FIG. 5, the information distribution apparatus 50 of this embodiment comprises: a memory 510 and a processor 520, and may further include an input-output interface 530, a network interface 540, a storage interface 550, and the like. These interfaces 530, 540, 550, the memory 510 and the processor 520 may be connected through a bus 560, for example. Wherein, the input-output interface 530 provides a connection interface for input-output devices such as a display, a mouse, a keyboard, and a touch screen. The network interface 540 provides a connection interface for various networked devices. The storage interface 550 provides a connection interface for external storage devices such as an SD card and a USB flash disk.

An embodiment of the present disclosure further provides a computer-readable storage medium on which a computer program is stored, characterized in that the program when executed by a processor implements any one of the foregoing information distribution methods.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disk storage, CD-ROM, optical storage device, etc.) having computer-usable program code embodied therein.

The present disclosure is described with reference to flowcharts and/or block diagrams of methods, apparatuses (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing apparatus to generate a machine such that the instructions executed by a processor of a computer or other programmable data processing apparatus to generate means implementing the functions specified in one or more flows of the flowcharts and/or one or more blocks of the block diagrams.

The computer program instructions may also be stored in a computer readable storage device capable of directing a computer or other programmable data processing apparatus to operate in a specific manner such that the instructions stored in the computer readable storage device produce an article of manufacture including instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

The above is merely preferred embodiments of this disclosure, and is not limitation to this disclosure. Within spirit and principles of this disclosure, any modification, replacement, improvement and etc. shall be contained in the protection scope of this disclosure.

What is claimed is:

1. An information distribution method, comprising:
determining a recommended value of a target indicator corresponding to a user based on a historical indicator of information historically distributed by the user and a historical indicator of a category to which the user belongs, wherein an indicator is determined based on resources gained and consumed through distributed information;
recommending the recommended value of the target indicator to the user;
determining target recipients of target information to be distributed by the user based on a target indicator input by the user, wherein the target indicator input by the user is determined based on the recommended value of the target indicator by the user; and
sending the target information to the target recipients.

2. The information distribution method according to claim 1, wherein the determining the recommended value of the target indicator corresponding to the user based on the historical indicator of the information historically distributed by the user and the historical indicator of the category to which the user belongs comprises:
determining a product of the historical indicator of the information historically distributed by the user and a user coefficient as a first value;
determining a product of the historical indicator of the category to which the user belongs and a category coefficient as a second value; and
determining a maximum of the first value and the second value as the recommended value of the target indicator.

3. The information distribution method according to claim 2, wherein the user coefficient is not greater than 3, and the category coefficient is between 0.7 and 0.9.

4. The information distribution method according to claim 3, wherein the user coefficient is 3, and the category coefficient is 0.8.

5. The information distribution method according to claim 2, further comprising:
determining a ratio of an indicator set by a user corresponding to each of multiple pieces of distributed information to an average indicator of a category to which the user belongs;
dividing the multiple pieces of the distributed information according to preset intervals to which ratios of the multiple pieces of the distributed information belong;
determining a completion rate of information corresponding to each of the intervals, wherein the completion rate is a ratio of a number of pieces of information each having an actual indicator not lower than a preset target indicator after information distribution to a number of pieces of information corresponding to the interval; and
determining the user coefficient based on a degree of decrease in the completion rate corresponding to each of the intervals with respect to a previous interval.

6. The information distribution method according to claim 5, wherein the multiple pieces of the distributed information are published information corresponding to at least one of a distribution platform or a distribution region of the target information.

7. The information distribution method according to claim 1, wherein the recommending the recommended value of the target indicator to the user comprises:
recommending the recommended value of the target indicator to the user in a case where a target indicator previously input by the user is not within a preset range.

8. The information distribution method according to claim 1, wherein the determining the target recipients of the target information to be distributed by the user based on the target indicator input by the user comprises:
for each recipient in a candidate recipient dataset, generating joint features of the recipient based on features of the recipient and features of the target information to be distributed by the user;
processing the joint features of the recipient using a pre-trained model to generate a predicted value; and
determining the recipient as a target recipient of the target information in a case where the predicted value meets a preset condition, wherein the preset condition is determined based on the target indicator input by the user.

9. The information distribution method according to claim 1, further comprising:
in a process of sending the target information to the target recipients, displaying at least one of the recommended value of the target indicator, drop information, gained resources, consumed resources or indicator(s) of the target information in real time by information visualization, wherein the drop information corresponding to each time is a ratio of resources gained at the time to resources gained at a previous time.

10. The information distribution method according to claim 1, further comprising:
in a process of sending the target information to the target recipients, monitoring drop information of the target information, wherein the drop information corresponding to each time is a ratio of resources gained at the time to resources gained at a previous time; and
recommending the recommended value of the target indicator to the user again in a case where the drop information is higher than a preset value and the target indicator input by the user is not the recommended value of the target indicator.

11. The information distribution method according to claim 1, further comprising:
obtaining distribution completion information of the target information after a distribution of the target information is completed, wherein the distribution completion information is determined based on a target indicator corresponding to the distribution and the target indicator input by the user; and
recommending the recommended value of the target indicator to the user again in a case where the target indicator input by the user is not the recommended value of the target indicator and the distribution completion information does not meet a preset condition.

12. An information distribution apparatus, comprising:
a memory; and
a processor coupled to the memory, the processor configured to, based on instructions stored in the memory, carry out an information distribution method comprising:
determining a recommended value of a target indicator corresponding to a user based on a historical indicator of information historically distributed by the user and a historical indicator of a category to which the user belongs, wherein an indicator is determined based on resources gained and consumed through distributed information;
recommending the recommended value of the target indicator to the user;
determining target recipients of target information to be distributed by the user based on a target indicator input by the user, wherein the target indicator input by the user is determined based on the recommended value of the target indicator by the user; and
sending the target information to the target recipients.

13. The information distribution apparatus according to claim 12, wherein the processor is configured to:
determine a product of the historical indicator of the information historically distributed by the user and a user coefficient as a first value;
determine a product of the historical indicator of the category to which the user belongs and a category coefficient as a second value; and
determine a maximum of the first value and the second value as the recommended value of the target indicator.

14. The information distribution apparatus according to claim 13, wherein the user coefficient is not greater than 3, and the category coefficient is between 0.7 and 0.9.

15. The information distribution apparatus according to claim 14, wherein the user coefficient is 3, and the category coefficient is 0.8.

16. The information distribution apparatus according to claim 13, wherein the processor is configured to:
determine a ratio of an indicator set by a user corresponding to each of multiple pieces of distributed information to an average indicator of a category to which the user belongs;
divide the multiple pieces of the distributed information according to preset intervals to which ratios of the multiple pieces of the distributed information belong;
determine a completion rate of information corresponding to each of the intervals, wherein the completion rate is a ratio of a number of pieces of information each having an actual indicator not lower than a preset target indicator after information distribution to a number of pieces of information corresponding to the interval; and
determine the user coefficient based on a degree of decrease in the completion rate corresponding to each of the intervals with respect to a previous interval.

17. The information distribution apparatus according to claim 16, wherein the multiple pieces of the distributed information are published information corresponding to at least one of a distribution platform or a distribution region of the target information.

18. The information distribution apparatus according to claim 12, wherein the processor is configured to:
recommend the recommended value of the target indicator to the user in a case where a target indicator previously input by the user is not within a preset range.

19. The information distribution apparatus according to claim 12, wherein the processor is configured to:
for each recipient in a candidate recipient dataset, generating joint features of the recipient based on features of the recipient and features of the target information to be distributed by the user;
processing the joint features of the recipient using a pre-trained model to generate a predicted value; and
determining the recipient as a target recipient of the target information in a case where the predicted value meets a preset condition, wherein the preset condition is determined based on the target indicator input by the user.

20. A non-transitory computer-readable storage medium on which a computer program is stored, the program when executed by a processor implementing an information distribution method comprising:
determining a recommended value of a target indicator corresponding to a user based on a historical indicator of information historically distributed by the user and a historical indicator of a category to which the user belongs, wherein an indicator is determined based on resources gained and consumed through distributed information;
recommending the recommended value of the target indicator to the user;
determining target recipients of target information to be distributed by the user based on a target indicator input by the user, wherein the target indicator input by the user is determined based on the recommended value of the target indicator by the user; and
sending the target information to the target recipients.
